(19) United States
(12) Patent Application Publication
(10) Pub. No.: US 2005/0078961 A1
(43) Pub. Date: Apr. 14, 2005

(54) System for transmitting signals in free space and method thereof

(76) Inventors: Chi-Luen Wang, Hsin Chu City (TW); Wun-Chen Lin, Taipei City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 10/681,902

(22) Filed: Oct. 10, 2003

(51) Int. Cl. H04B 10/00

(52) U.S. Cl. 398/129

(57) ABSTRACT

A method for transmitting signals in a free space, in which a pair of transmission terminals is disposed. Each of the transmission terminals has a laser transceiver for transmitting and/or receiving laser signals. Before transmitting laser signals, each of the transmission terminals uses an optical alignment component to perform alignment. The laser transceiver and the optical alignment component both transmit and receive laser beams via a single optical component. The sets the laser transceivers of the pair of the transmission terminals to transmit and/or receive laser signals via different wavelengths, uses a visible laser beam sent from the optical alignment component to align the laser transceivers to each other before transmitting or receiving the laser signals and sets each of transmission terminals to transmit and receive the laser signals via a common axial direction.

### FIELD OF THE INVENTION

The present invention is directed to a system for transmitting signals in free space and a method thereof, and more particularly, to a system and method that employ an optical component (a collimating lens is preferred) to align and transmit laser beams sent from one laser transceiver to the other laser transceiver in free space and use a visible laser beam sent from the optical alignment component to align the laser transceivers to each other so as to make the laser transceivers transmit laser signals in a predetermined axial direction.

### BACKGROUND OF THE INVENTION

In accordance with prior art, systems for point-to-point transmission in free space are widely used in the communication field. Although strongly challenged by the fiber-based communication system, the systems for point-to-point transmission in free space are still more convenient as they do not require the existence of a fiber network. In particular, when the amount of data for transmission is not huge, such systems are more competitive than the fiber-based communication system.

In the free-space communication systems, systems using lasers to transmit data are increasingly popular. Laser-using systems do not require execution of the annoying process of frequency coordination as do microwave communication systems. Besides, in contrast to the traditional copper-based or fiber-based communication systems, since laser-using systems do not require physical communication lines, they are more economic. For instance, if two buildings in a campus need to transmit data to each other, the free-space laser communication system is a good choice. The user only needs to set a pair of laser transceivers on the roofs of the two buildings. Further, the free-space laser communication system also can be used to communicate between offices of a building.

Reference is made to FIG. 1, which is a schematic diagram of a conventional free-space laser transmission system 50. The free-space laser transmission system 50 has two transmission terminals 60 and 70. The transmission terminals 60 and 70 respectively have optical receiving components 62, 70 and optical transmitting components 64, 74 to receive or transmit laser beams. The laser beam 66 is sent from the optical transmitting component 64 of the transmission terminal 60 and received by the optical receiving component 72 of the transmission terminal 70. The other laser beam 67 is sent from the optical transmitting component 74 of the transmission terminal 70 and received by the optical receiving component 62 of the transmission terminal 60. The laser beam 66 and 67 both include encoded data. For the transmission terminal 60, the received laser beam 67 is passed to the optical signal processor 65 for processing (e.g. decoding) and the same occurs for received laser beam 66 at optical signal processor 75 of the transmission terminal 70. The optical signal processors 65, 75 also can be used to output the laser beams 66, 67 via the optical transmitting components 64, 74, respectively.

In the free-space laser transmission system 50, before transmitting data between the transmission terminals 60, 70, additional telescope 68, 78 should be set to align optical transmitting component 64, 74 with the optical receiving components 62, 72, respectively. Although the free-space laser transmission system 50 can be quickly set and has fewer limits in bandwidth, it transmits and receives laser beams via different optical components and needs additional telescopes to align the optical transmitting component to the optical receiving component before transmitting data. Hence, its cost is increased due to the additional telescopes. Further, it also takes more time to align the optical transmitting and receiving components.

### SUMMARY OF THE INVENTION

An objective of the present invention is to provide a method for transmitting signals in free space, which uses a single optical component for a laser transceiver including a single fiber bi-directional type laser transceiver and one directional type transmitter and receiver modules to transmit and/or receive laser signals. Further, the method of the invention employs an optical alignment component to input a visible laser beam into an optical fiber of a transmission terminal for alignment before transmitting signals. Hence, the signal transmission and beam alignment are performed both via the optical component so as to keep the laser signals and visible laser beam transmitted in a common axial direction. For single fiber bi-directional type laser transceiver, the wavelengths of transmission terminal pair are different so that the transmitted and received laser signals in the single transmission terminal do not interfere with each other and are easily separated at the optical signal processors.

With these objectives in mind, the present invention provides a method for transmitting signals in free space. A pair of transmission terminals is disposed in free space. Each of the transmission terminals has a laser transceiver and an optical alignment component. The laser transceiver and the optical alignment component both transmit and/or receive laser beams via a single optical component, preferably a collimating lens. The method comprises: setting the laser transceivers of the pair of the transmission terminals to transmit and/or receive laser signals via different wavelengths; using a visible laser beam sent from the optical alignment component to align the laser transceivers to each other before transmitting or receiving the laser signals; and setting each of transmission terminals to transmit and receive the laser signals via a common axial direction.

Numerous additional features, benefits and details of the present invention are described in the detailed description, which follows.

### BRIEF DESCRIPTION OF THE DRAWINGS

The foregoing aspects and many of the attendant advantages of this invention will become more readily appreciated as the same becomes better understood by reference to the following detailed description, when taken in conjunction with the accompanying drawings, wherein:

FIG. 1 is a schematic diagram of a conventional free-space laser transmission system;

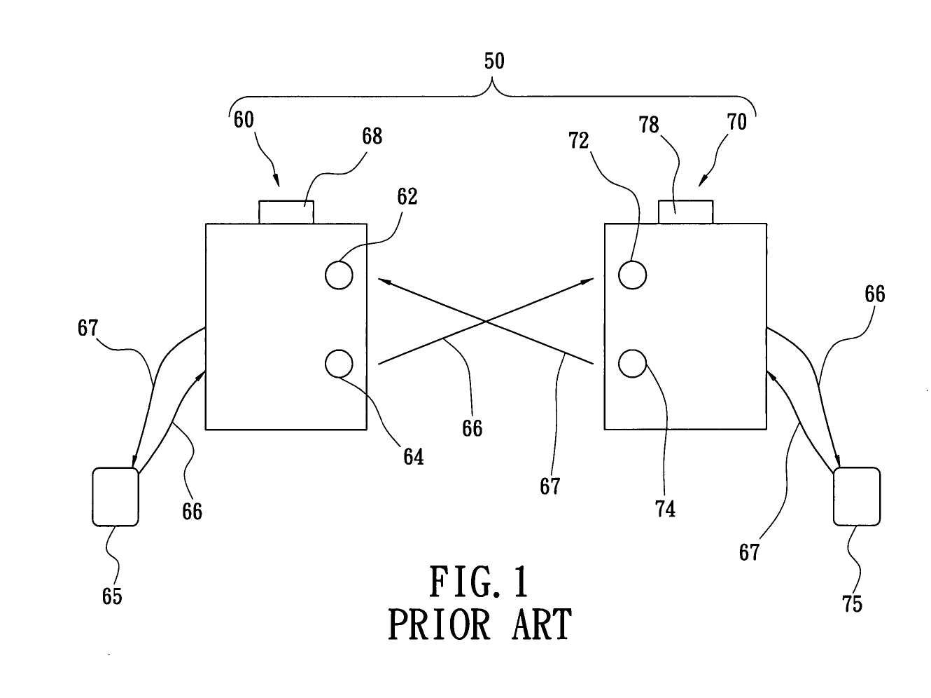

FIG. 2 is a schematic diagram of a free-space laser transmission system in accord with the present invention; and

FIG. 3 is a simple flow chart of a method for transmitting signals in free space in accord with the present invention.

### DETAILED DESCRIPTION

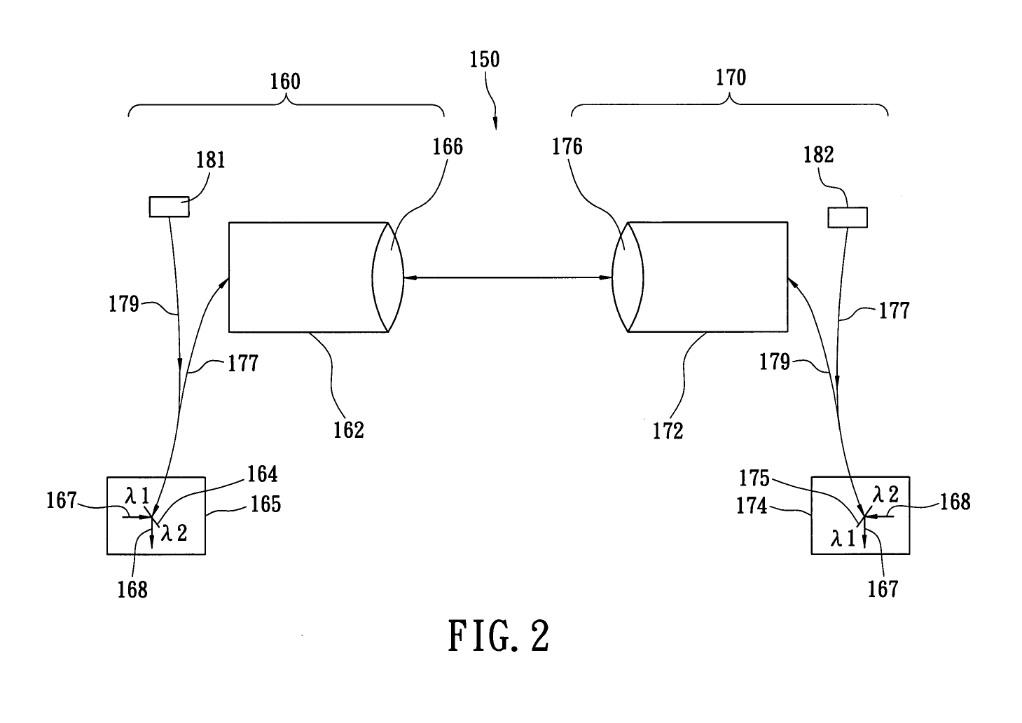

Reference is made to FIG. 2, which is a schematic diagram of a free-space laser transmission system 150 in accord with the present invention. The free-space laser transmission system 150 can be adapted to multiple transmission terminals. However, for simplicity, this embodiment only has two transmission terminals 160, 170. The transmission terminals 160, 170 have laser transceivers 162, 172 for transmitting or receiving laser signals to/from each other, respectively. (In this embodiment, the transmission terminals 160, 170 are a transmission pair.) The transmission terminals 160, 170 also have optical signal processors 164, 174 to process (decode) received signals or to input laser signals to the laser transceivers 162, 172, respectively. For each of the transmission terminals 160, 170, the wavelengths of the transmitted or received laser signals are different (designated as by subscript 1 and 2, respectively) to prevent them from interfering with each other. Since the wavelengths of the transmitted and received laser signals are different, the beam-splitting lenses 165, 175 of the optical signal processors 164, 174 can easily separate the transmitted and received laser signals. Preferably, the transmission terminals 160, 170 use optical fibers 177, 179 to the optical signal processors 164, 174, respectively. The laser transceivers 162, 172 have collimating lenses 166, 176 disposed at their beam output ends to make the output laser beams uniform. Hence, the laser beams can be transmitted in a parallel manner, not in a dispersive manner.

When the transmission terminal 160 transmits/receives laser signals to/from the transmission terminal 170, the laser signal 167 designated with a subscript 1 passes through optical fiber 177 and the laser transceiver 162 and is transmitted to the laser transceiver 172 of the transmission terminal 170. Then, the laser signal 167 is passed to the optical signal processor 174 of the transmission terminal 170 via the optical fiber 179. Likewise, for the transmission terminal 160, the laser signal 168 designated with a subscript 2 from the transmission terminal 170 is first separated from the laser signal 167 by the beam-splitting lens 175 of the optical signal processor 174 and then is passed to the transceiver 172 via the optical 179. Subsequently, the laser signal 168 is transmitted to the laser transceiver 166 of the transmission terminal 160 and passed to the optical signal processor 164 of the transmission terminal 160 via the optical fiber 177. The bean-splitting lens 165 of the optical signal processor 164 also can clearly separate the laser signals 167, 168 designated by subscripts 1 and 2, respectively.

The transmission terminals 160, 170 perform beam alignment by using visible laser beams, such as ruby laser beams. The transmission terminals 160, 170 have optical alignment components 181, 182 coupled with optical fiber 179, 177 to output the visible laser beams via the collimating lens 166, 176 for performing beam alignment before transmitting signals. The laser transceivers 162, 172 and optical alignment components 181, 182 transmit/receive laser signals or visible laser beams via single optical components, preferably collimating lens 166, 167, respectively. Hence, while the visible laser beams are aligned with the optical components of the laser transceivers 162, 172 (such as the collimating lenses 166, 176), the laser signals 167, 168 are also aligned with the optical components. Hence, after performing beam alignment, in the viewpoint of the transmission terminals, the laser signals is transmitted or received in a common axial direction.

The optical signal processors 164, 174 further have encoders/decoders (not shown) to encode/decode the laser signals 167, 168.

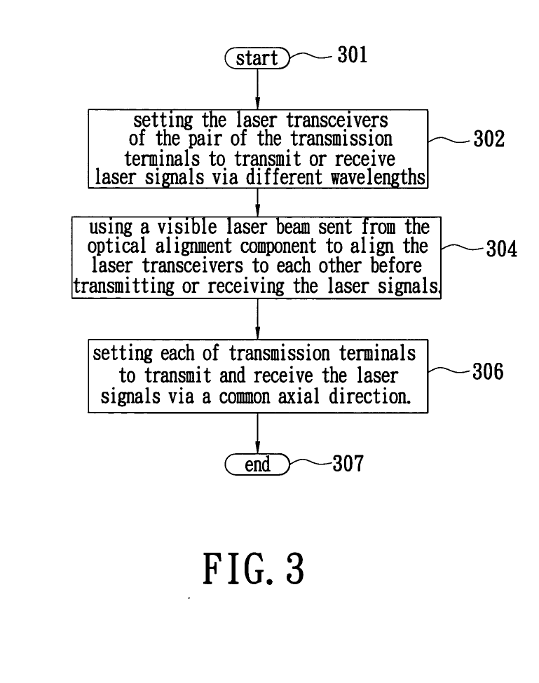

Reference is made to FIG. 3, which is a simple flow chart of a method for transmitting signals in free space in accord with the present invention. The method for transmitting signals in free space is applied with a pair of transmission terminals disposed in the free space. Each of the transmission terminals has a laser transceiver with a single optical component for transmitting or receiving laser signals. The method comprises the following steps:
Step 301: start;
Step 302: the laser transceivers of the pair of the transmission terminals is set to transmit or receive laser signals via different wavelengths;
Step 304: a visible laser beam sent from the optical alignment component is used to align the laser transceivers to each other before transmitting or receiving the laser signals;
Step 306: each of transmission terminals is set to transmit and receive the laser signals via a common axial direction; and
Step 307: end.

In the present invention, a laser transceiver is first disposed in a free space, preferably the roof of a building. Before transmitting laser signals, an optical alignment component is used to output a visible laser beam via an optical component, such as the collimating lens mentioned above, for alignment. After performing alignment, the laser transceiver also transmits or receives laser signals via the optical component and employs laser beams with different wavelengths to transmit and receive laser signals, respectively. Since the laser transceiver and the optical alignment component both transmit via the single optical component, once the alignment is performed, the laser signals are transmitted and received via a predetermined axial direction.

Further, the method of the present invention further includes a step for providing a beam-splitting lens to distinguish transmitted laser signals from received laser signals. For a transmission terminal, since the wavelengths of the transmitted and received laser signals are different, the transmitted and received laser signals can be separated easily via the beam-splitting lens. Hence, the signal interference between the transmitted and received laser signals can be eliminated.

Additionally, disposing a collimating lens in front of the laser transceiver can make the transmitted laser signals uniform. The collimating lens can also serve as the single optical component, through which the laser transceiver and optical alignment component can transmit laser signals and perform alignment.

Further, the method provides an optical fiber to output or input the laser signals with the different wavelengths. The optical fiber is coupled with the optical alignment component to align the transmission terminals to each other via the optical component. The optical fiber provides the flexibility of locations of/between the optical component and the laser transceiver. The method also provides an encoder and decoder at each transmission terminal to encode or decode the laser signals. The encoder and decoder can be disposed in an optical signal processor and the optical signal processor can connect with the laser transceiver via the optical fiber.

Compared with the conventional techniques, the present invention provides a method for transmitting signals between two transmission terminals in free space. It uses two laser beams with different wavelengths to convey data and uses a single optical component to transmit/receive laser signals so as to make the transmission terminals able to transmit/receive laser signals in a common axial direction once alignment is performed by the optical alignment component. Thereby, the system according to the present invention doesn't need additional telescopes to align the two transmission terminals. Moreover, since the present invention uses laser beams with different wavelengths to transmit and receive signals, the interference between the transmitted and received signals can be eliminated.

Although the present invention has been described with reference to the preferred embodiment thereof, it will be understood that the invention is not limited to the details thereof. Various substitutions and modifications have been suggested in the foregoing description, and other will occur to those of ordinary skill in the art. Therefore, all such substitutions and modifications are embraced within the scope of the invention as defined in the appended claims.

1. A method for transmitting signals in a free space, wherein a pair of transmission terminals is disposed in the free space, each of the transmission terminals having a laser transceiver and an optical alignment component, the laser transceiver and the optical alignment component both transmitting and/or receiving laser beams via a single optical component, the method comprising:
setting the laser transceivers of the pair of the transmission terminals to transmit or receive laser signals via different wavelengths;
using a visible laser beam sent from the optical alignment component to align the laser transceivers to each other before transmitting or receiving the laser signals; and
setting each transmission terminal to transmit and receive the laser signals via a common axial direction.

2. The method as claimed in claim 1, further comprising:
providing a beam-splitting lens to distinguish transmitting laser signals from received laser signals.

3. The method as claimed in claim 1, further comprising:
providing a collimating lens as the optical component.

4. The method as claimed in claim 1, further comprising:
providing an optical fiber to output or input laser signals with different wavelengths.

5. The method as claimed in claim 4, further comprising:
coupling the optical fiber with the optical alignment component before outputting or inputting laser signals with different wavelengths so as to align the transmission terminals to each other via the optical component and the optical fiber.

6. The method as claimed in claim 1, further comprising:
providing a flexibility of locations of/between the optical component and the laser transceiver via an optical fiber.

7. The method as claimed in claim 1, further comprising:
providing an encoder and a decoder at each transmission terminal to encode or decode the laser signals.

8. The method as claimed in claim 1, further comprising:
providing the laser signals transmitted and received from a transmitter module to a receiver module in an one-direction manner.

9. The method as claimed in claim 1, further comprising:
providing the laser signals transmitted and received from a transmitter module to a receiver module in a bi-direction manner.

10. A system for transmitting signals in a free space, comprising:
a pair of transmission terminals, wherein each transmission terminals has a laser transceiver to transmit or receive laser signals; and
an optical alignment component used to align the laser transceivers of the pair of the transmission terminals;
wherein the laser transceiver and the optical alignment component transmit or receive laser beams via a optical component so as to keep the laser transceiver transmitting or receiving the laser signals in a predetermined axial direction, and laser signals having different wavelengths are input and output for each transmission terminal.

11. The system as claimed in claim 10, wherein each transmission terminal has a collimating lens as the optical component to make output laser signals uniform.

12. The system as claimed in claim 10 further comprising a optical fiber for light coupling, the optical fiber providing a flexibility of locations of/between the optical component and the laser transceiver.

13. The system as claimed in claim 10, wherein each transmission terminal has an encoder and a decoder to encode or decode the laser signals.

14. The system as claimed in claim 10, wherein the laser transceiver is a single transmitter module or receiver module so as to provide the laser signals transmitted and received in an one-direction manner.

15. The system as claimed in claim 10, wherein the laser transceiver is a integrated transmitter/receiver module so as to provide the laser signals transmitted and received in an bi-direction manner.

16. The system as claimed in claim 10, wherein each transmission terminal couples to an optical fiber to output or input the laser signals.

17. The system as claimed in claim 16, wherein the optical alignment component is coupled with the optical fiber to output a visible laser beam to align the laser transceivers to each other before transmitting or receiving the laser signals.

18. The system as claimed in claim 16, further comprising a beam-splitting lens coupled with the optical fiber to distinguish input laser signals from output laser signals.
